(19) United States
(12) Patent Application Publication
(10) Pub. No.: US 2015/0118340 A1
(43) Pub. Date: Apr. 30, 2015

(54) Apparatus for melting recycled thermoplastics

(71) Applicants: Michael F. Tuck, Knoxville, TN (US); Richard E. Spears, Clinton, TN (US)

(72) Inventors: Michael F. Tuck, Knoxville, TN (US); Richard E. Spears, Clinton, TN (US)

(21) Appl. No.: 13/998,383

(22) Filed: Oct. 28, 2013

(51) Int. Cl. B29C 39/24; B29C 39/38; B29C 39/44

(52) U.S. Cl. CPC B29C 39/24; B29C 39/44; B29C 39/38
USPC 425/144

(57) ABSTRACT

An apparatus for melting thermoplastics comprises a metal hopper having an upper portion with sides tapering inwardly at a first selected angle from the vertical; a lower portion with sides tapering inwardly at a second angle from the vertical, where the second angle is greater than the first angle; and, a discharge area at the bottom of the lower portion. At least one hopper heating element is disposed on the wall(s) of the hopper adjacent to the junction between the first and the second portions. A heated mold is positioned below the discharge area to collect the melted thermoplastic. A control system independently controls the hopper heating element(s) and the mold heating element(s). The metal hopper has a cover that is opened for loading and closed during melting; the top surface of the hopper is preferably angled downward toward the user for ease of loading.

### BACKGROUND OF THE INVENTION

1. Field of the Invention

The invention pertains to apparatus and methods for melting thermoplastic scrap materials. More particularly, the invention pertains to apparatus and methods for melting expanded polystyrene to reduce the volume prior to shipment for reprocessing into other useful articles.

2. Description of Related Art

A great deal of plastic waste is generated both domestically and worldwide; this waste material is burdensome to dispose of in landfills, but at the same time it is a potentially useful material if it can be recycled relatively efficiently. One waste stream in particular is the expanded polystyrene used in institutional food services such as school cafeterias and the like. Large volumes of material exist, but they are cumbersome to package and ship either to landfills or to recycling operations, because they are very low density, so that a small mass of material takes up a lot of space in dumpsters, trash haulers, and recycling centers.

One promising approach to this problem is to have a relatively inexpensive device that can be deployed at the source (say, a high school cafeteria) to melt down the expanded polystyrene articles. The resulting densified material can be shipped more efficiently, typically by truck, and the process heat largely eliminates odor and health hazards from traces of leftover food on the original waste plastic.

Various devices and systems have been proposed to address this application. Wenzel et al., U.S. Pat. No. 5,470,521, disclose a system that employs a stream of heated air at a temperature effective to thermally densify thermoplastic waste; a related system is disclosed by Sable et al., U.S. Pat. No. 5,654,862. It will be appreciated that the use of forced, heated air leads to some energy loss as hot air is ultimately discharged from the system.

Major, in U.S. Pat. No. 8,202,077, discloses a substantially rectangular upper hopper that is insulated and a lower hopper that is also insulated and contains heating elements or pads on various surfaces. An insulated, heated tray compartment at the bottom contains a trapezoidal tray for collecting the melted polystyrene.

### OBJECTS AND ADVANTAGES

Objects of the present invention include the following: providing a system for melting thermoplastics for efficient transport from a waste generation site; providing a system for reducing the volume of expanded polystyrene prior to recycling; providing a system for melting expanded thermoplastic materials that is more energy efficient; providing a system for recycling thermoplastics that has more accurate temperature control; providing a system for reducing expanded thermoplastic materials to a shape that can be efficiently transported; and providing a system for converting food-contaminated plastic waste to a form suitable for recycling. These and other objects and advantages of the invention will become apparent from consideration of the following specification, read in conjunction with the drawings.

### SUMMARY OF THE INVENTION

According to one aspect of the invention, an apparatus for melting thermoplastics comprises:
an insulated housing having an openable cover at the top to allow loading of material to be melted;
a metal hopper disposed within the housing and having:
   an upper portion with sides tapering inwardly at a first angle from the vertical;
   a lower portion with sides tapering inwardly at a second angle from the vertical, the second angle greater than the first angle; and,
   a discharge area at the bottom of the lower portion;
at least one hopper heating element disposed on the wall(s) of the hopper adjacent to the junction between the first and second portions;
a removable mold positioned below the discharge area to collect the melted thermoplastic, the mold including at least one mold heating element; and,
a control system that independently controls the hopper heating element(s) and the mold heating element(s).

According to another aspect of the invention, an apparatus for melting thermoplastics comprises:
an insulated housing having an openable cover at the top to allow loading of material to be melted;
a metal hopper disposed within the housing and having:
   an upper portion with sides tapering inwardly at a first angle from the vertical;
   a lower portion with sides tapering inwardly at a second angle from the vertical, the second angle greater than the first angle;
   a central heating tube assembly, the assembly comprising a sheet metal structure having at least one heating element on its underside; and,
   a discharge area at the bottom of the lower portion;
at least one hopper heating element disposed on the wall(s) of the hopper adjacent to the junction between the first and second portions;
a removable mold positioned below the discharge area to collect the melted thermoplastic, the mold including at least one mold heating element; and,
a control system that independently controls the hopper heating element(s), the mold heating element(s), and the central tube heating element(s).

### BRIEF DESCRIPTION OF THE DRAWINGS

The drawings accompanying and forming part of this specification are included to depict certain aspects of the invention. A clearer conception of the invention, and of the components and operation of systems provided with the invention, will become more readily apparent by referring to the exemplary, and therefore non-limiting embodiments illustrated in the drawing figures, wherein like numerals (if they occur in more than one view) designate the same elements. The features in the drawings are not necessarily drawn to scale.

FIG. 1 is a schematic diagram in cross section of one example of the present invention.

FIG. 2 is a schematic diagram of the process flow in accordance with another example of the invention.

### DETAILED DESCRIPTION OF THE INVENTION

In its most general form, the invention comprises an insulated metal hopper having generally sloping sides and a relatively close-fitting top cover. Waste plastic items are loaded into the top of the hopper and the cover is closed. Heating pads disposed at selected places provide the necessary heat to melt and consolidate the plastic material, which flows downward, assisted by the sloping walls, into an angled mold. A control system manages the heating process and improves energy efficiency.

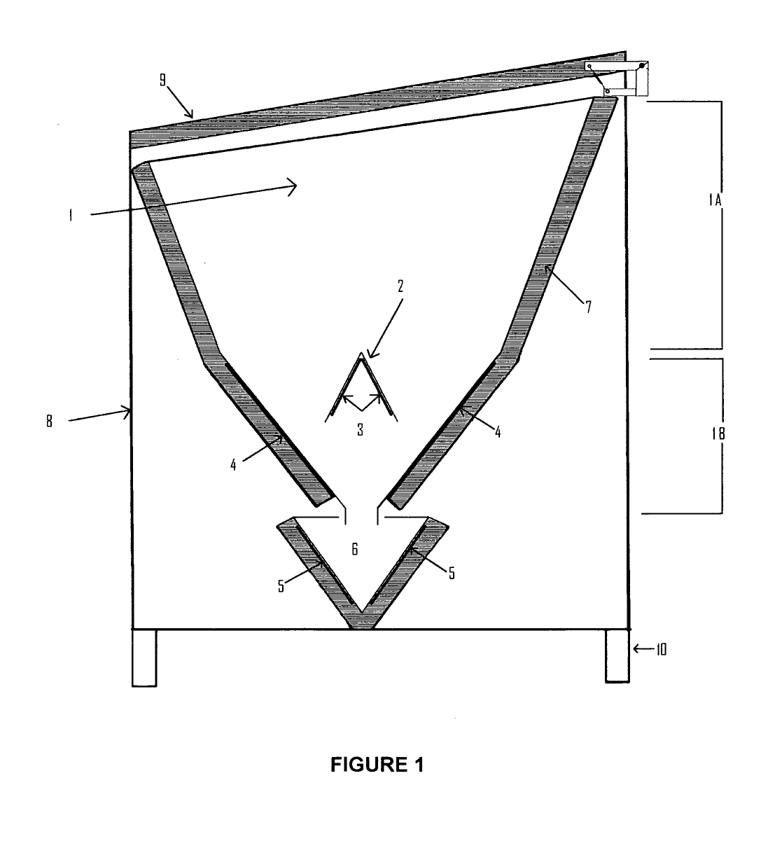

A schematic illustration of the apparatus is shown in FIG. 1. The following examples will illustrate various aspects of the invention so that those skilled in the art will have a fuller understanding of its construction and features. It will be understood that these are exemplary in nature and are not intended to limit the scope of the invention as it is defined in the claims.

### EXAMPLE

As shown in FIG. 1, the hopper 1 is preferably configured with inwardly-sloping sides, none of which are substantially vertical. In the example shown, the walls of the upper part of the hopper 1A form a first angle (preferably about 5-20° with respect to vertical), and the walls of the lower part of the hopper 1B form a second angle (preferably about 30-60° with respect to vertical).

Applicant has found that sloping walls provide a significant performance advantage over the vertical hopper as taught, e.g., by Major in U.S. Pat. No. 8,202,077. As heat is applied to expanded polystyrene the initial stage at around 270° F., the material begins to shrink. The sloping walls improve the movement of the deforming polystyrene to the area lower in the tank in which higher temperatures convert the EPS to a liquid. Angles of 5-20° for the top adequately allow this movement and angles of 30-60° in the lower section keep material flowing into the mold. In the vertical-wall hopper of Major, shrinkage of the load will inevitably create random gaps, which decrease heat transfer and create openings through which heated air can flow upward, diminishing the overall efficiency of the system.

### EXAMPLE

The hopper 1 is made of sheet metal and may be fabricated by any conventional means. The metal is preferably thick enough to provide the necessary structural rigidity yet not so thick as to add unnecessary weight or thermal mass to the system or present too much of a barrier to rapid heat transfer from the heaters to the scrap. Applicants have found that a welded structure of 16-gauge stainless steel is quite suitable.

It will be appreciated that other materials and fabrication techniques may be used to make the hopper. Some materials include aluminum, carbon steel, stainless steel, brass, titanium, or other suitable alloys. Individual panels may be joined by welding, brazing, riveting or other mechanical fasteners, etc. Applicants prefer welding, but it will be appreciated that if mechanical fasteners are used, the seams can be arranged to avoid having exposed fasteners protruding into the hopper, where they might impede the generally downward movement of the scrap plastic. It will be further understood that the hopper may be plated, anodized, or given other surface treatments as are well known in the art.

### EXAMPLE

Heating of the plastic charge is provided by flat heaters placed at several locations on the walls of the hopper. Mica heating elements 4 with a power density of 1.1-1.7 W/in² are placed on two sides of the hopper in the lower portion. A central heating tube assembly 2 is provided, preferably in the form of a sheet metal structure having an inverted V shape; two silicone heating pads 3 at 2-3 W/in² are affixed to the undersides of the triangular shape. The mold area 6 also has two silicone heating pads 5 at 2-3 W/in².

### EXAMPLE

A control system manages power to the heaters 3, 4, 5 to maintain a temperature sufficient to densify the scrap while minimizing wasted energy. As an example, the division into three separately controlled and measured heating zones will allow for reducing or eliminating the power consumption of sections of the unit not being used for the final stage of the process which is removing the remaining air in the mold 6 through maintaining the mold container temperature at 400-550° F. to keep the material in a liquid state thus eliminating more of the gas in the material. The system taught by Major does not allow for power reduction, as the entire assembly is evidently treated as a single heating zone. In Applicants' design, each zone also preferably has reporting capabilities that provide diagnostic feedback for zone alarms, such as over-temperature and heating zone failures. Furthermore, an internal logic system can be programmed to set heating curves that more closely match the heating pads' natural curve.

### EXAMPLE

A heated mold 6 is provided at the bottom of the system, into which the melted plastic flows. It will be understood that the interior volume of the mold may be of any suitable size and shape; because the mold is preferably a one-piece design for simplicity of loading and unloading, the mold will preferably have inwardly sloping sides to provide adequate draft for the solidified plastic to be easily removed from the mold. Applicants have found that a mold in the shape of a triangular prism is particularly suitable for several reasons. First, the triangular shape provides a large draft angle to allow the block to easily come out of the mold. Second, the large, flat sloping sides of the mold facilitate the placement of heating pads 5 directly on the mold. Third, the resulting cast triangular prisms are easily stacked to minimize shipping volume from the source generator to the recycling plant, which was noted to be one of the main objectives of waste consolidation at the source.

The heating configuration of the mold container consists of two silicone heating pads 5 mechanically connected parallel to the sides of the mold container. Thermocouples are installed to provide temperature feedback to the logic system

The heated mold assembly of the present invention has notable advantages over the heated tray compartment taught by Major. Air does not conduct heat nearly as well as metal and by minimizing the air space surrounding the mold Applicants are able to achieve higher temperatures more quickly, thereby reducing the total processing time of the material.

### EXAMPLE

Insulating materials are used to retain heat in the system. Three inch mineral wool insulation material 7 is preferably applied to all sides of the tank to retain heat in the tank and to minimize heat transfer to the outer casing. Other suitable insulating materials as are well known in the art may be used, such as fiberglass, ceramic insulating board, etc.

### EXAMPLE

The hopper, heaters, and collection mold are preferably contained in a housing or cabinet 8 having sufficient structural rigidity to allow the apparatus to be moved about while protecting the internal components and control system. A conventional sheet metal cabinet is preferred; Applicants have found 16 gauge powder coated carbon steel to be particularly suitable. Skids, leveling devices, casters 10 or other routine features for ease of movement or placement may be provided as are known in the art.

The housing has a rigid cover 9 that covers the top of the hopper and preferably opens to the rear, either with a rear hinge or by sliding. The top surface of hopper 1 is preferably angled downward toward the front for ease of loading. The downward angle is preferably between 5° and 10° from the horizontal, and more preferably from 7° to 9° from horizontal.

The cabinet 8 further has a small access door near the bottom (not shown) so that the collection mold 6 can be removed.

It will be appreciated that in many cases it will be desirable to locate the unit out of doors, such as on a loading dock or near other waste containers. Thus, the housing 8 and cover 9 may be configured to be water resistant and to protect the electronic controls, wiring, and insulation 7 from the elements. Conventional safety features such as ground straps, circuit breakers, and ground-fault detectors may be provided as are well known in the art.

The device is self-contained and relatively simple to operate. It may be configured to operate on any desired power supply. Applicants prefer to operate from a 220 V source, but it will be understood that the invention may easily be modified for other power sources, such as 115 V single phase, and power cabling may be configured to mate with various standard outlet configurations as may be used in the United States or abroad.

### EXAMPLE

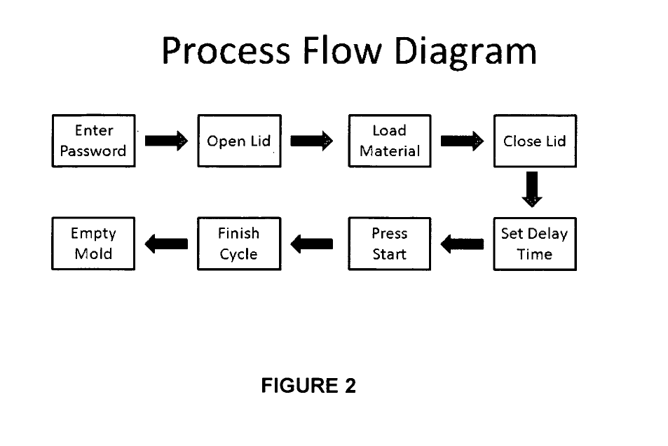

Referring to FIG. 2, the method of operation may be described as follows: The user enters his/her chosen password using the control box keypad, at which point the system unlocks the lid. The lid 9 is opened to allow loading of the EPS material. Once the material is loaded the lid is closed and a 5-60 second lock timer begins. The user returns to the control panel and enters the desired delay time. The system will automatically lock once the timer has reached 0 or the user presses the start key prior to the timer expiring. Once the system has completed its cycle (as an example, for 10 kg of material the cycle time is preferably in the range of 3-7 hours, and typically about 5 hours), and the internal temperature has been reduced to 110° F., the password is entered to unlock the lid and mold compartment door. When the unit has undergone two full loads the mold is removed from the unit and emptied. The mold is placed back in the unit for the next run.

If abnormal or emergency situations are experienced an emergency stop hard button is preferably located on the side of the control box allowing immediate shut down. Green and red led indicators are preferably provided to display in use (red) and ready (green). Conventional interlocks may be provided to insure that the lid is fully closed before the cycle begins.

1. An apparatus for melting thermoplastics comprising:
an insulated housing having an openable cover at the top to allow loading of material to be melted;
a metal hopper disposed within said housing and having:
an upper portion with sides tapering inwardly at a first angle from the vertical;
a lower portion with sides tapering inwardly at a second angle from the vertical, said second angle greater than said first angle;
a central heating tube assembly mounted transversely within said lower portion, said assembly comprising a sheet metal structure with sides tapering outwardly toward said inwardly-tapering hopper sides and having at least one heating element on the underside thereof; and,
a discharge area at the bottom of said lower portion;
at least one hopper heating element disposed on the wall(s) of said hopper adjacent to the junction between said first and said second portions;
a removable mold positioned below said discharge area to collect said melted thermoplastic, said mold including at least one mold heating element; and,
a control system that independently controls said hopper heating element(s) and said mold heating element(s).

2. The apparatus of claim 1 wherein said first angle is 5-20° from the vertical and said second angle is 30-60° from the vertical.

3. The apparatus of claim 1 wherein the upper surface of said hopper slopes downward toward the front at an angle between 5° and 10° from the horizontal.

4. The apparatus of claim 1 further comprising an interlock system to prevent the unit from operating when said cover is open.

5. The apparatus of claim 1 wherein said control system is programmable to set heating curves that correspond to said heating elements' natural curve(s).

6. (canceled)

7. The apparatus of claim 1 wherein said at least one heating element on said central heating tube assembly is controllable independently from said hopper heating element(s) and said mold heating element(s).

8. An apparatus for melting thermoplastics comprising:
an insulated housing having an openable cover at the top to allow loading of material to be melted;
a metal hopper disposed within said housing and having:
an upper portion with sides tapering inwardly at a first angle from the vertical;
a lower portion with sides tapering inwardly at a second angle from the vertical, said second angle greater than said first angle;
a central heating tube assembly mounted transversely within said lower portion, said assembly comprising a sheet metal structure in the shape of an inverted V so that its sides taper outwardly toward said inwardly tapering sides of said hopper, and having at least one heating element on its underside; and,
a discharge area at the bottom of said lower portion;
at least one hopper heating element disposed on the wall(s) of said hopper adjacent to the junction between said first and said second portions;
a removable mold positioned below said discharge area to collect said melted thermoplastic, said mold including at least one mold heating element; and,
a control system that independently controls said hopper heating element(s), said mold heating element(s), and said central tube heating element(s).

9. The apparatus of claim 8 wherein said first angle is 5-20° from the vertical and said second angle is 30-60° from the vertical.

10. The apparatus of claim 8 wherein the upper surface of said hopper slopes downward toward the front at an angle between 5° and 10° from the horizontal.

11. The apparatus of claim 8 further comprising an interlock system to prevent the unit from operating when said cover is open.

12. The apparatus of claim 8 wherein said control system is programmable to set heating curves that correspond to said heating elements' natural curve(s).
